(19) United States
(12) Patent Application Publication
(10) Pub. No.: US 2025/0378328 A1
(43) Pub. Date: Dec. 11, 2025

(54) Binary Classification of Dead Detector Elements in a Flat Panel Detector Using a Convolutional Neural Network

(71) Applicant: The Board of Regents of the University of Oklahoma, Norman, OK (US)

(72) Inventors: Isaac B. Rutel, Choctaw, OK (US); Jonthomas M. Box, Blanchard, OK (US)

(21) Appl. No.: 19/235,047

(22) Filed: Jun. 11, 2025

Related U.S. Application Data
(60) Provisional application No. 63/658,677, filed on Jun. 11, 2024.

(51) Int. Cl. G06N 3/08

(52) U.S. Cl. CPC G06N 3/08

(57) ABSTRACT

A method comprises: performing training of an initial machine model using a first dataset of a first digital detector to create a trained machine model; performing testing on the trained machine model using a second dataset of a second digital detector to create a tested machine model; and performing validation on the tested machine model using a third dataset of the second digital detector, wherein the training, the testing, and the validation are at a resolution of a single pixel corresponding to a single detector element of either the first digital detector or the second digital detector.

### CROSS-REFERENCE TO RELATED APPLICATIONS

This claims priority to U.S. Prov. Patent App. No. 63/658,677 filed on Jun. 11, 2024, which is incorporated by reference.

### STATEMENT REGARDING FEDERALLY SPONSORED RESEARCH OR DEVELOPMENT

Not applicable.

### BACKGROUND

Medical physicists routinely perform quality assurance on digital detection systems, part of which involves the testing of flat panel detectors. Flat panels may degrade over time as an increasing number of individual detector elements begin to malfunction. The pixels that correspond to these elements are “corrected for” by using information elsewhere in the detector system, however these corrected elements still constitute a loss in image quality for the system as a whole.

Digital image receptors are thus manufactured with some number of inherently defective or dead detector elements. As detectors are used and age, this number of elements may increase, degrading the image quality and overall health of the imaging system. These dead detector elements do not, in practice, show up as defective pixels in images acquired using the detector, as they are corrected for using information from functioning pixels elsewhere in the image. Any corrected element is a point of information loss for every image taken on that detector for the rest of the detector's lifetime.

The methods used to correct the images, as well as the location and number of dead detector elements, are often only available to the vendor of the digital detection system, but not to the medical physicist responsible for the quality assurance of the system. It has been shown that as the number of corrected elements in a detector increase, the image quality of that detector decreases. Vendors have access to the location and number of dead elements in a system, but are not required to share this information with the owner of the system, or the medical physicist responsible for the quality assurance of the system.

It would be desirable for diagnostic medical physicists to have their own techniques to access dead detector element maps for systems that they routinely perform quality assurance services on. It is to satisfying such a goal that the present disclosure is directed.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the inventive concepts disclosed herein. The figures are not necessarily to scale and certain features and certain views of the figures may be shown as exaggerated in scale or in schematic in the interest of clarity and conciseness.

FIG. 1 shows low exposure resulting in a “noise like” image (upper panel), and high exposure resulting in visible detector geometry (lower panel).

FIG. 2 shows a sub image creation schema in which a 3×3 sliding window moves from left to right across each row of pixels in the image. A 32×32 window as opposed to a 3×3 window is used. Remainder pixels at the edge of each image were discarded from the analysis.

FIG. 3 shows workflows of model training, testing, and validation. Models are trained on detectors A/B and are tested and validated on B/A, indicating that the detector used for training is always the opposite of the detector used for testing and validation.

FIG. 4 shows ground truth maps and predicted dead detector element maps for the validation set of the high and low exposure data sets Trilogy (left) and 21 EX (right). Models were trained, tested, and validated using the for-processing pixel values.

FIG. 5 shows ground truth maps and predicted dead detector element maps for the validation set of the high and low exposure data sets Trilogy (left) and 21 EX (right). Models were trained, tested, and validated using the standard deviation data. The dotted white rectangle represents the detector area shown in FIG. 6.

FIG. 6 shows ground truth (a), prediction (b), and subtraction image (c) for 21 EX low using the low exposure data set. This is an area outlined in FIG. 5, but enlarged for ease of comparison.

FIG. 7 shows confusion matrices for each model: a) 21 EX, low exposure set, for-processing pixel value model; b) Trilogy, low exposure set, for-processing pixel values; c) 21 EX, high exposure set, for-processing pixel values; d) Trilogy, high exposure set, for-processing pixel values; e) 21 EX, low exposure set, standard deviation preprocessing; f) Trilogy, low exposure set, standard deviation preprocessing; g) 21 EX, high exposure set, standard deviation preprocessing; and h) Trilogy, high exposure set, standard deviation preprocessing.

FIG. 8 shows pixel value histograms for images taken from Trilogy and 21 EX from the low and high exposure data sets, respectively. Arrows indicate pixel value saturation.

FIG. 9 shows pixel value standard deviation histograms for images taken from Trilogy and 21 EX from the low and high exposure data sets, respectively. Arrows indicate pixel value saturation.

FIG. 10 is a flowchart of a method of binary classification of dead detector elements.

FIG. 11 is a schematic diagram of an apparatus according to an embodiment of the disclosure.

### DETAILED DESCRIPTION

The present disclosure is directed to a novel technique for classifying dead detector elements at single pixel resolution by using standard deviation. The technique can be trained on one detector, and then tested and validated on another, demonstrating its ability to be generalized to other types of detectors. In a non-limiting embodiment, the technique utilizes 3 flat-field, or “noise,” images to be taken to predict the dead detector element maps for the system. Flat-field images are images obtained without and object and are composed of noise characteristics of a digital detector and vendor-corrected pixel data. Models using only for-processing pixel data were unable to successfully generalize from one detector to the other. “For-processing” or “for processing” images are defined by the DICOM standard as image data that has been corrected for defective detector elements, nonuniformity of the x-ray field, gain and offset of pixels, etc. This is similar to the term “original data,” which is the term employed by the IEC and is considered interchangeable in the medical imaging field. Standard deviation data is data produced prior to training by taking multiple (e.g., 3) for-processing images acquired at the same exposure conditions and finding the standard deviation for each detector element response by calculating the standard deviation of the digital numbers for each pixel location using the digital number for the pixel location in each of the for-processing images acquired at a given x-ray exposure. The standard deviation value calculated for each detector element/pixel location is then placed in a new image at the detector element/pixel location forming a single new image comprised of the standard deviation values from the set of for-processing images. Models preprocessed using the standard deviation across three for-processing images were able to classify dead detector element maps with an F₁ score ranging from 0.4527 to 0.8107 and recall ranging from 0.5420 to 0.9303 with better performance, on average, observed using the low exposure data set. The F₁ score is the harmonic mean of precision and recall and has a range of 0-1, where 1 is the best score. Precision and recall, which are defined below, are performance metrics that apply to data retrieved from a dataset and likewise have ranges of 0-1, where 1 is the best score. A high exposure data set in this context includes radiographic exposures that will saturate large portions of the individual detector elements. Saturation occurs when the system no longer differentiates between the dose and larger doses and is assigned the same digital number value. In contrast, the low exposure data are formed from exposures that do not exceed the maximum dose where the system can no longer differentiate between the given dose and a larger dose.

Since the correction algorithms used by vendors are proprietary knowledge and deep learning-based correction methods are currently being developed, it is desirable to develop a method of dead element detection that uses the most general information possible, as opposed to tailoring the technique to a specific correction algorithm type. This would provide the method the best chance at being generalizable, not just from one detector to another, but between different detectors from different vendors. The method of the present disclosure uses AI training to detect corrected detector elements from flat field exposures. CNNs, specifically, can be used to solve many problems in computer vision, including noisy images. Detector elements are classified based on the surrounding pixel data.

The presently-disclosed methods build on U.S. Patent App. Pub. No. 2023/0079742, which is incorporated by reference and which utilized CNNs and noise images to classify small areas of detectors based on the percentage of dead elements present. Specifically, the previous method is extended significantly to classify individual elements in the detector. In addition, all models are trained on one detector, then tested and validated on a different detector in order to evaluate the generalizability of the method. How the type of exposure used to generate the noise images affects model performance is also investigated to be able to recommend exposure parameters to physicists who may implement this tool.

Vendors correct for dead detector elements by providing artificial, calculated information for each dead detector element. The corrections may look valid to the naked eye, but do not actually provide accurate information. The disclosed methods may be applied after such corrections to determine dead detector elements notwithstanding the corrections.

Before further describing various embodiments of the apparatus, component parts, and methods of the present disclosure in more detail by way of exemplary description, examples, and results, it is to be understood that the embodiments of the present disclosure are not limited in application to the details of apparatus, component parts, and methods as set forth in the following description. The embodiments of the apparatus, component parts, and methods of the present disclosure are capable of being practiced or carried out in various ways not explicitly described herein. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description. While the apparatus, component parts, and methods of the present disclosure have been described in terms of particular embodiments, it will be apparent to those of skill in the art that variations may be applied to the apparatus, component parts, and/or methods and in the steps or in the sequence of steps of the method described herein without departing from the concept, spirit, and scope of the inventive concepts as described herein. All such similar substitutes and modifications apparent to those having ordinary skill in the art are deemed to be within the spirit and scope of the inventive concepts as disclosed herein.

All patents, published patent applications, and non-patent publications referenced or mentioned in any portion of the present specification are indicative of the level of skill of those skilled in the art to which the present disclosure pertains, and are hereby expressly incorporated by reference in their entirety to the same extent as if the contents of each individual patent or publication was specifically and individually incorporated herein.

Unless otherwise defined herein, scientific and technical terms used in connection with the present disclosure shall have the meanings that are commonly understood by those having ordinary skill in the art. Further, unless otherwise required by context, singular terms shall include pluralities and plural terms shall include the singular.

As utilized in accordance with the methods and compositions of the present disclosure, the following terms and phrases, unless otherwise indicated, shall be understood to have the following meanings: The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to, 2, 3, 4, 5, 6, 7, 8, 9, 10, 15, 20, 30, 40, 50, 100, or any integer inclusive therein. The phrase “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z.

As used in this specification and claims, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the terms “about” or “approximately” are used to indicate that a value includes the inherent variation of error for the apparatus, composition, or the methods or the variation that exists among the objects, or study subjects. As used herein the qualifiers “about” or “approximately” are intended to include not only the exact value, amount, degree, orientation, or other qualified characteristic or value, but are intended to include some slight variations due to measuring error, manufacturing tolerances, stress exerted on various parts or components, observer error, wear and tear, and combinations thereof, for example. The terms “about” or “approximately”, where used herein when referring to a measurable value such as an amount, percentage, temporal duration, and the like, is meant to encompass, for example, variations of ±20% or ±10%, or ±5%, or ±1%, or ±0.1% from the specified value, as such variations are appropriate to perform the disclosed methods and as understood by persons having ordinary skill in the art. As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, all numerical values or ranges include fractions of the values and integers within such ranges and fractions of the integers within such ranges unless the context clearly indicates otherwise. Thus, to illustrate, reference to a numerical range, such as 1-10 includes 1, 2, 3, 4, 5, 6, 7, 8, 9, 10, as well as 1.1, 1.2, 1.3, 1.4, 1.5, etc., and so forth. Reference to a range of 1-50 therefore includes 1, 2, 3, 4, 5, 6, 7, 8, 9, 10, 11, 12, 13, 14, 15, 16, 17, 18, 19, 20, etc., up to and including 50, as well as 1.1, 1.2, 1.3, 1.4, 1.5, etc., 2.1, 2.2, 2.3, 2.4, 2.5, etc., and so forth. Reference to a series of ranges includes ranges which combine the values of the boundaries of different ranges within the series. Thus, to illustrate reference to a series of ranges, for example, a range of 1-1,000 includes, for example, 1-10, 10-20, 20-30, 30-40, 40-50, 50-60, 60-75, 75-100, 100-150, 150-200, 200-250, 250-300, 300-400, 400-500, 500-750, 750-1,000, and includes ranges of 1-20, 10-50, 50-100, 100-500, and 500-1,000. The range 100 units to 2000 units therefore refers to and includes all values or ranges of values of the units, and fractions of the values of the units and integers within said range, including for example, but not limited to 100 units to 1000 units, 100 units to 500 units, 200 units to 1000 units, 300 units to 1500 units, 400 units to 2000 units, 500 units to 2000 units, 500 units to 1000 units, 250 units to 1750 units, 250 units to 1200 units, 750 units to 2000 units, 150 units to 1500 units, 100 units to 1250 units, and 800 units to 1200 units. Any two values within the range of about 100 units to about 2000 units therefore can be used to set the lower and upper boundaries of a range in accordance with the embodiments of the present disclosure. More particularly, a range of 10-12 units includes, for example, 10, 10.1, 10.2, 10.3, 10.4, 10.5, 10.6, 10.7, 10.8, 10.9, 11.0, 11.1, 11.2, 11.3, 11.4, 11.5, 11.6, 11.7, 11.8, 11.9, and 12.0, and all values or ranges of values of the units, and fractions of the values of the units and integers within said range, and ranges which combine the values of the boundaries of different ranges within the series, e.g., 10.1 to 11.5.

As used herein any reference to “we” as a pronoun herein refers generally to assistants or other contributors who assisted in data collection and manipulation and is not intended to represent an inventorship role by said assistants or other contributors in any subject matter disclosed herein.

The inventive concepts of the present disclosure will be more readily understood by reference to the following examples and embodiments, which are included merely for purposes of illustration of certain aspects and embodiments thereof, and are not intended to be limitations of the disclosure in any way whatsoever. Those skilled in the art will promptly recognize appropriate variations of the apparatus, compositions, components, procedures and method shown below.

The following abbreviations apply:
AI: artificial intelligence
ASIC: application-specific integrated circuit
cm: centimeter(s)
CNN: convolutional neural network
CPU: central processing unit
DICOM: Digital Imaging and Communication in Medicine
DSP: digital signal processor
EO: electrical-to-optical
FN: false negative
FP: false positive
FPGA: field-programmable gate array
IEC: International Electrotechnical Commission
kVp: kilovoltage(s) peak
mAs: milliampere-second(s)
OBI: on-board imaging
OE: optical-to-electrical
RAM: random-access memory
RF: radio frequency
ROM: read-only memory
RX: receiver unit
SRAM: static RAM
TCAM: ternary content-addressable memory
TP: true positive
TX: transmitter unit.

### Methods

Two data sets of flat field images were obtained from the OBI systems of a Varian 21EX and a Varian Trilogy linear accelerator. These systems were used because of a lack of access to the dead detector maps on diagnostic detection systems from the surrounding hospitals, whereas the dead detector maps for these linear accelerators' OBI systems were readily available.

The flat field images were split into high and low exposure data sets described in section 2.A. These data sets were then preprocessed and a CNN model was trained, tested, and validated for each in order to evaluate the effect of exposure type on model performance. Additionally, one model was created using only for-processing pixel values. This model serves as a baseline for comparison against the models generated using standard deviation data, as described in section 2.B. The purpose of this method is to generate several different CNN models for the task of predicting dead element maps from flat field images in order to narrow down the choice of exposure type and select the best performing model for future use.

### 2.A. Datasets

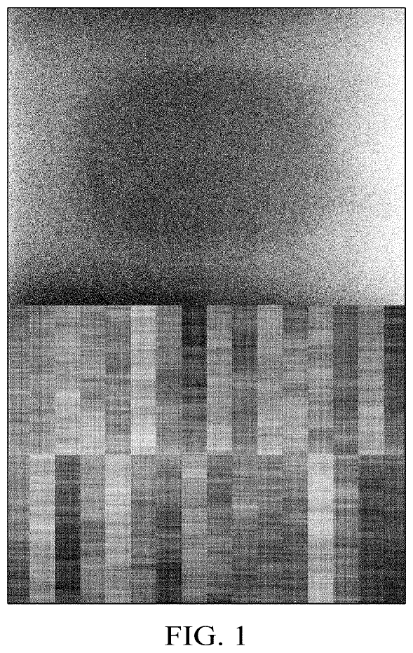

Twenty-one and twenty-four exposures were taken from the OBI systems attached to the Trilogy and 21 EX linear Accelerators, respectively. Each image was acquired at a 150 cm source-to-image distance and using techniques that resulted in apparent low noise images that displayed the detector geometry, called the high exposure set, and techniques that resulted in “noise like” images that showed no detector geometry, called the low exposure set. A representative image of each set is shown in FIG. 1. The exposure parameters are listed in Table 1. Each exposure was repeated three times to enable the measurement of standard deviation between exposures. Each image was composed of 1536×2048 grayscale pixels with a bit depth of 16.

TABLE 1
Image acquisition parameters for Trilogy and 21
EX for the high and low exposure data sets.

| Model | kVp | mAs |
|---|---|---|
| Trilogy High Exposure Set | 60 | 2.56 |
| | 80 | 2.56 |
| | 100 | 2.56 |
| | 120 | 1.28 |
| Trilogy Low Exposure Set | 60 | 0.512 |
| | 80 | 0.512 |
| | 120 | 0.256 |
| 21 EX High Exposure Set | 60 | 2.56 |
| | 80 | 2.56 |
| | 100 | 2.56 |
| | 120 | 1.28 |
| 21 EX Low Exposure Set | 60 | 0.512 |
| | 80 | 0.512 |
| | 100 | 0.512 |
| | 120 | 0.256 |

### 2.B. Data Preprocessing

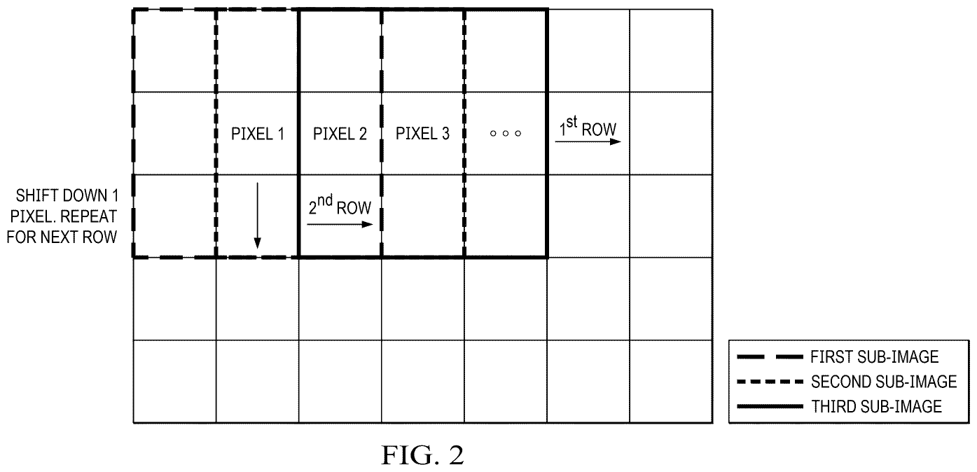

Models were trained using either the for-processing pixel values or the standard deviation values across three images taken with the same exposure parameters. Data was normalized to a mean of zero and a variance of one. Prior to model training, images were split into 32×32 sub-images, each shifted 1 pixel over from the previous sub-image. FIG. 2 demonstrates this schema with a smaller, 3×3 sub-image size. Using this schema, every pixel in the image belongs to a unique sub-image, except for the pixels in an area 16 pixels wide around every edge of the image. For training data, the pixel in the 17^{th} row and 17^{th} column of the sub-image was labeled as either dead or functional according to the dead element map.

Because of this labeling scheme, each image contained over three million sub-images. These sub-images could not be loaded into RAM simultaneously due to hardware constraints. To combat this problem, as well as the imbalanced nature of the data, under-sampling was used. The under-sampling scheme sampled all dead detector elements in each image, as they were the minority class by a ratio of roughly 1:1,000. Additionally, approximately 10% of the remaining pixels were randomly sampled as well. From this combined sample, a standard 80/20 train/test split was performed to generate the training and testing sets.

### 2.C. Model Architecture

Each model was created using Python 3.7 and Tensorflow 2.3.0 and consisted of a CNN composed of 6 convolutional layers, a single 50% dropout layer, and 2 fully connected layers. Every convolutional layer utilized a sigmoid activation function, and batch normalization was performed between each layer of the model.

### 2.D. Training and Testing Models

Model training and testing is critical to generating a robust model, i.e., a model that can perform well on a wide range of data. A key component of training and testing is ensuring that a model is not overfit to the training data. Overfitting occurs when a model learns the training data set so well that it will no longer generalize to other data. Models were trained and tested on either the high exposure data set or the low exposure data set. Testing and validation have come to be used interchangeably in many fields of study. Here testing is referred to as the process of hyper-parameter tuning and early stopping designed to generate a high performing model that is not overfit to the training set, and validation is referred to as the process of evaluating a model for the final time on an unseen dataset.

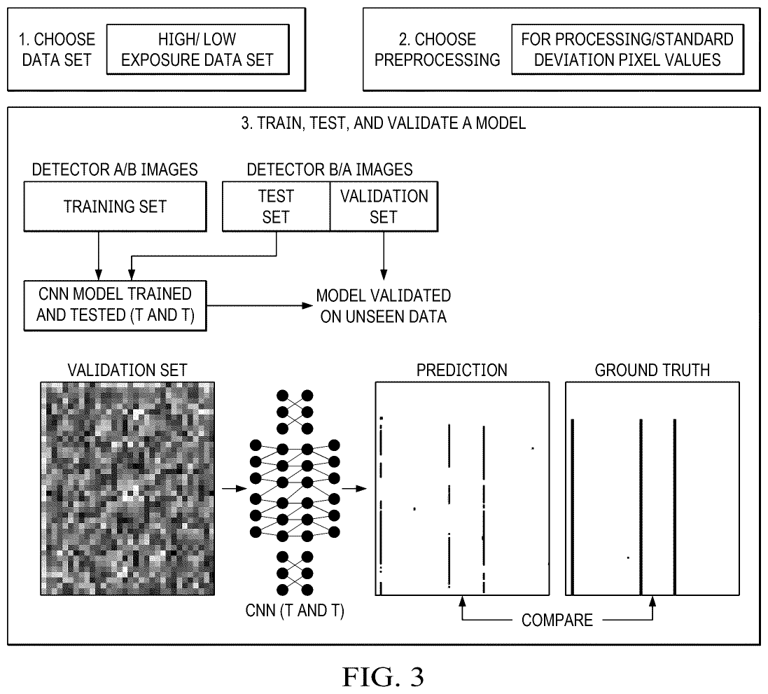

Models were trained on one detector, and then tested and validated on the other detector to evaluate how well they could generalize to other detectors. This process was repeated using the high and low exposure sets and with standard deviation preprocessing and for presentation pixel values. The workflow for model generation is summarized in FIG. 3. Training was conducted using either the for-processing pixel data alone, composed of either 9 or 12 exposures at varying technique, or the standard deviation calculated from three exposures utilizing the same technique, which resulted in a training set size of either 3 or 4 standard deviation images. Tensorflow's categorical cross entropy loss function was used to perform training and testing. Early stopping and the dropout layer were used to prevent overfitting. Early stopping monitored the test loss after each epoch and would terminate training if the test set loss did not decrease over a period of 50 epochs.

### 2.E. Model Validation

The validation set consisted of images acquired from the opposite detector from which the training was performed, but of the same preprocessing and exposure type, i.e., if standard deviation preprocessing and the low exposure data set was used for training and testing, it was likewise used for validation. The validation set was divided into sub-images in the same fashion as the training and testing data. This data was then scaled using the standard scaler that had been fit to the training set. The trained model then classified each sub image as 0, or 1, corresponding to 17^{th}×17^{th} detector element being functional or dead, respectively. These predictions were then stitched back together to create predicted dead detector element maps for the validation set.

Once a model was trained and tested, and the loss indicated training was stopped prior to overfitting, the model was then used to generate predictions on the validation data set. These predictions were evaluated using the precision, recall, and F₁ score metrics defined as follows:

$$Precision = \frac{TP}{FP + TP} \qquad ( Eq . 1 )$$

$$Recall = \frac{TP}{FN + TP} \qquad ( Eq . 2 )$$

$${F}_{1} = 2 * \frac{Precision * Recall}{Precision + Recall} = \frac{TP}{\frac{( FN + FP )}{2} + TP} \qquad ( Eq . 3 )$$

where TP, FP, FN are defined as true positive, false positive, and false negative predictions, respectively.

Accuracy is not the best metric for evaluating model performance in problems such as this where the vast majority of pixels are functional. Instead, the above metrics, which are more widely used in classification tasks, were applied to the classification task in this disclosure. These metrics reflect the ability to correctly identify dead detector elements while minimizing false positives, the ability to correctly identify dead detector elements while minimizing false negatives, and the harmonic mean between the two, respectively. The F₁ score is used as a replacement for accuracy, as it takes both precision and recall into account.

### Results

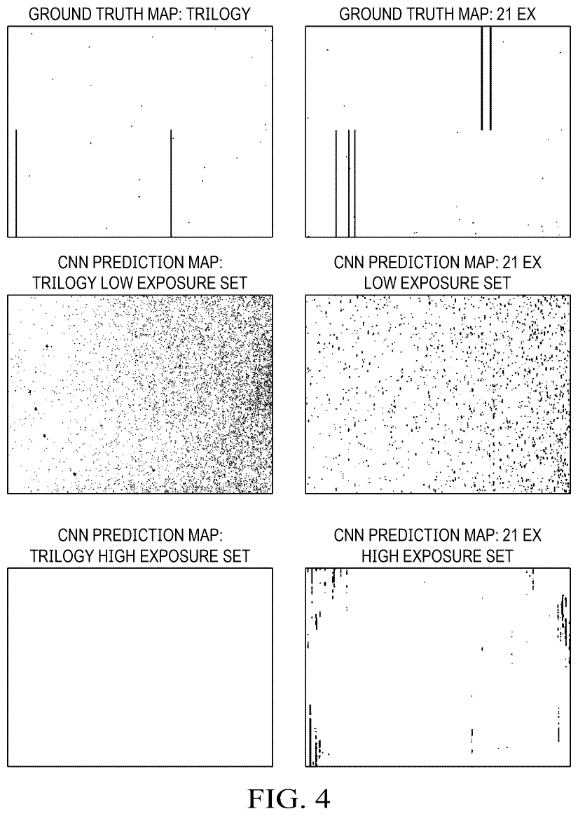

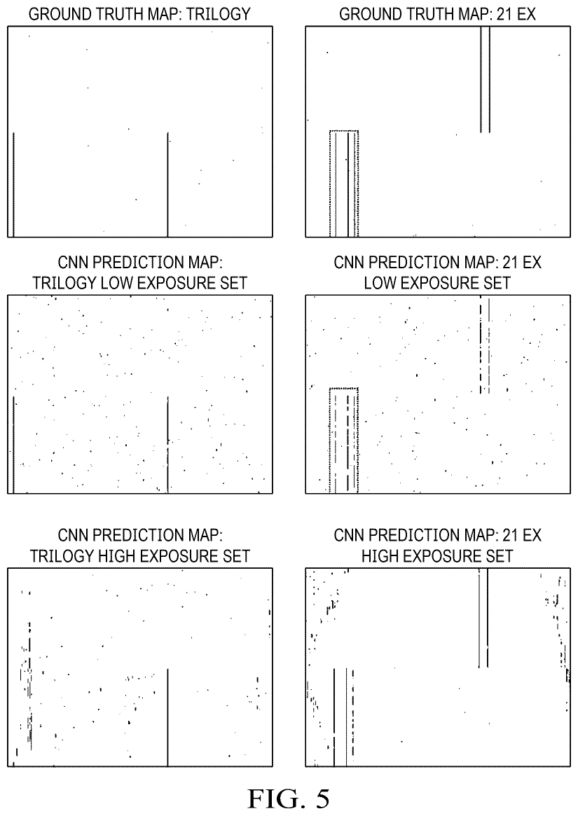

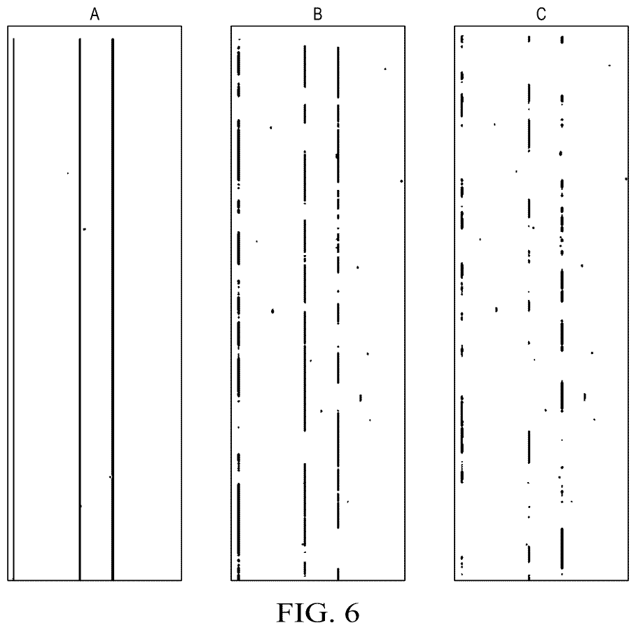

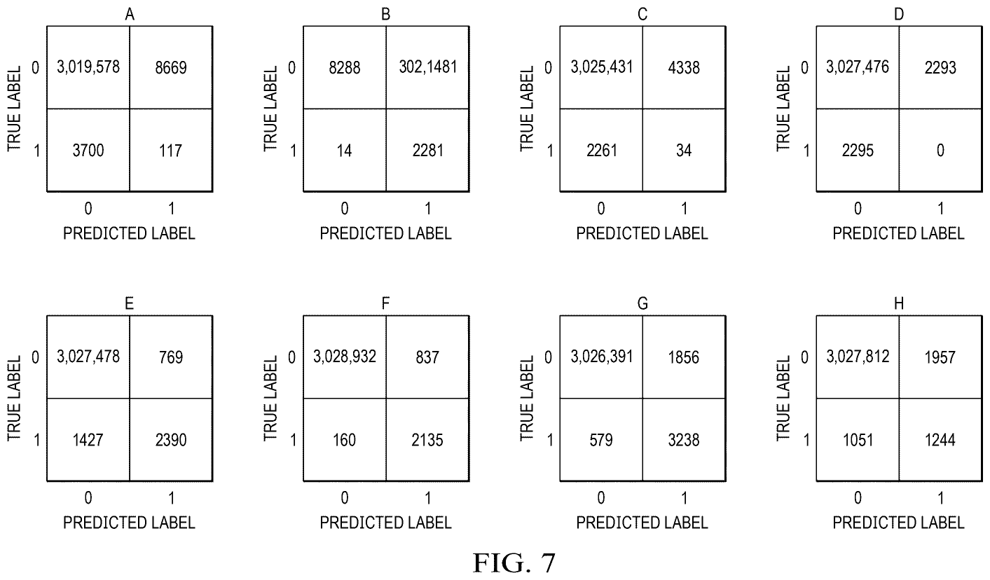

The models generated using standard deviation preprocessing and standard scaler normalization showed the most promise in localizing dead detector elements, as opposed to those trained on for-processing pixel data. This can be seen when comparing the ground truth maps to the predicted maps in FIGS. 4-6, and in the confusion matrices in FIG. 7. Confusion matrices are widely used in classification problems as they visually depict the performance of a classification model. The true label axis is vertical, and the predicted label axis is horizontal. A label of 0 corresponds to functional elements, and a label of 1 corresponds to dead elements. The number of elements on the diagonal of the confusion matrix corresponds to correctly classified elements.

Visually, the for-processing pixel data models do not correctly predict any of the vertical line clusters of dead elements found in the ground truth pixel maps, as opposed to the models using standard deviation preprocessing, which shows many of the dead detectors for line geometry. This is confirmed by the poor precision, recall, and F₁ scores shown in Table 2. These metrics indicate significantly lower performance for the for-processing pixel data models compared to the models using standard deviation preprocessing, which translates to a much higher number of false positive dead pixels and false negative dead pixels.

TABLE 2
Model performance for all validation sets

| Model | Precision | Recall | F₁ Score |
|---|---|---|---|
| Low Exposure, For-Processing Pixel | 0.013 | 0.031 | 0.019 |
| Values, 21 EX | | | |
| Low Exposure, For-Processing Pixel | 0.01 | 0.9939 | 0.02 |
| Values, Trilogy | | | |
| High Exposure, For-Processing Pixel | 0.01 | 0.01 | 0.01 |
| Values, 21 EX | | | |
| High Exposure, For-Processing Pixel | 0 | 0 | 0 |
| Values, Trilogy | | | |
| Low Exposure, Standard Deviation | 0.757 | 0.6261 | 0.685 |
| Pixel Values, 21 EX | | | |
| Low Exposure, Standard Deviation | 0.718 | 0.931 | 0.811 |
| Pixel Values, Trilogy | | | |
| High Exposure, Standard Deviation | 0.6357 | 0.848 | 0.727 |
| Pixel Values, 21 EX | | | |
| High Exposure, Standard Deviation | 0.3886 | 0.5420 | 0.4527 |
| Pixel Values, Trilogy | | | |

Table 2 indicates the wide variance in model performance for different preprocessing techniques and exposure types, seen in the F₁ scores which vary between 0.019 and 0.811. The wide variance suggests that for-processing pixel data alone is not sufficient to train a CNN for this task, but it also suggests that the best model is created using a set of low exposure images combined into one standard deviation image. This result may narrow down the types of models created in future experiments and also give a baseline model which may be tested clinically.

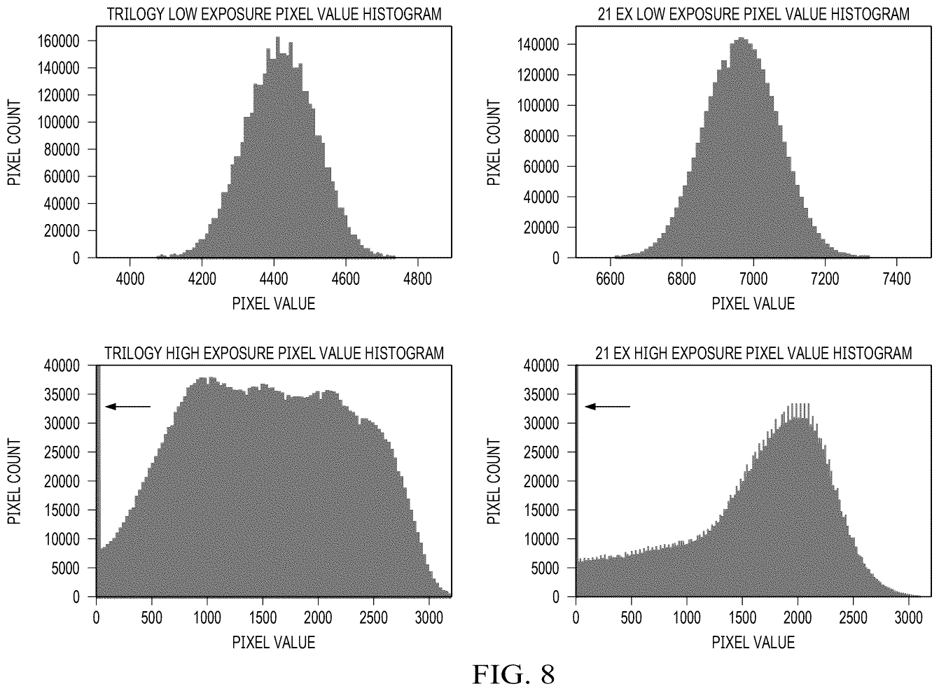

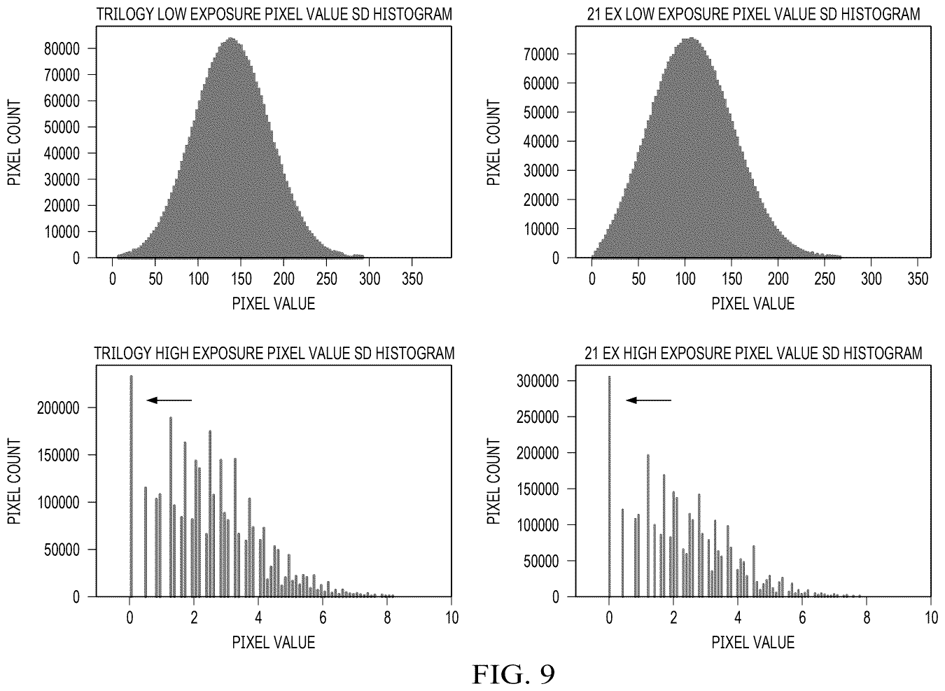

When comparing model performance within exposure types, one model was validated on the 21 EX detector and one model was validated on the Trilogy detector, model performance is better using the low exposure data set, having an average precision, recall, and F₁ score of 0.737, 0.778, and 0.748, as compared to the high exposure set, having an average precision, recall, and F₁ score of 0.512, 0.695, and 0.590, respectively. The histograms in FIGS. 8 and 9 depict the pixel value and standard deviation pixel value distributions, respectively. The high exposure data set distributions are skewed left because of a large number of zero values. This is an example of pixel saturation due to overexposure. This saturation is not seen in the low exposure dataset, which may account for the increased performance of models trained on the lower exposure data.

### Discussion

The present disclosure focuses on training artificial neural networks for a specific task, and finding information in low contrast environments. Given the difficulty of identifying features in this environment, narrowing the focus of training input choice may help to tune models and training sets to better utilize neural networks for this task.

The final evaluation of the present model supports the idea that a user can classify individual detector elements as dead or as functional by training a CNN on a separate detector with known dead detector map information. This indicates that supervised training methods have some success generalizing when tasked with this particular problem, at least for image acquisition systems from the same vendor. The importance of data preprocessing is evident when comparing the range of model performance across the different data sets. This is found in the marked performance improvement when comparing the for-processing to the preprocessed standard deviation trained model results.

Considering all of the presented models, those models that are generated using the low exposure data set may perform better than those trained on the high exposure set. This is seen in the higher F₁ score for the Trilogy system, where the lower exposure data (0.8107) appear much improved over the high exposure data (0.4527). In contrast, the 21 EX system, shows the higher exposure data (0.7267) has a better F₁ score compared to the lower exposure data (0.6852), where the higher exposure data now appears to provide marginally better results.

A medical physicist without access to the vendor's dead element maps can use the results of this work to monitor the health of their detection system by predicting the overall number of dead elements present and tracking that number over time. Vendors may report the number of detector elements that are no longer working or may only include those detector elements for which the system can no longer make corrections, and this reported value may be used to compare to CNN analysis results. For that purpose, the percent error between the absolute number of dead elements present and estimated by the CNN models was also calculated. The average percent error was found to be 23.4% and 36.5% for the low and high exposure sets, respectively. The lower exposure model also provides a more accurate estimation of the number of dead detector elements from the dead pixel map. If one imagines using this data to provide actionable results for a vendor, such as further testing, a more detailed investigation or panel replacement, the accuracy of model predicted estimations will likely play a role in the acceptance of this type of analysis.

The present work can be expanded by acquiring data from additional vendors and detector types to produce a more generalizable model. Performance may also be increased through the development of a task-specific AI system, as opposed to the relatively generic CNN structure in this disclosure. CNN uncertainty estimation techniques can also be used to evaluate model stability as a function of exposure. However, this disclosure suggests that exposure may only play a minor role in model performance, with preprocessing techniques, e.g., the choice to use standard deviations over for-processing pixel values, playing a much larger role. Uncertainty measures will also lend credibility to any decisions made utilizing this technique, such as detector replacement if a sufficient portion of elements, as determined by the vendor, is predicted to be dead.

This method can currently be used to predict dead detector element maps on diagnostic digital radiography systems where multiple exposures can be taken and combined into a standard deviation image. In a non-limiting embodiment, this image would then be passed in 32×32 image chunks into the best performing model, the low exposure Trilogy model, and the model predictions would be combined to generate the predicted dead element map. This could be performed alongside the annual quality assurance inspection of the machine and would provide additional information related to the health of the digital detector.

### Pseudo-Labeling

Pseudo-labeling is a specific type of semi-supervised learning technique that utilizes a previously trained supervised model and an unlabeled data set. The supervised model makes predictions on the unlabeled data set, and the predictions that have the highest confidence are included into a new, larger training set. This process can be repeated by making predictions on the unlabeled data with the newly trained model, and retraining again on the data set. However, it is computationally more expensive to do so.

To perform pseudo-labeling, a new unlabeled data set from 3 clinically used, diagnostic flat panel radiography systems was acquired. Data utilized in the pseudo-labeling model generation was scaled using the Scikit-learn library's StandardScaler method. In the pseudo-labeling pipeline, after scaling images were divided into overlapping 32×32 sub-images. Each sub-image was then labeled according to the pixel in the 17^{th} column and 17^{th} row of the sub-image.

The previously trained Low Exposure, Standard Deviation Pixel Values, Trilogy model was used to predict the dead pixel maps of the unlabeled data set. Once these maps were predicted, all sub-images with class probability less than 99% were dropped from the analysis. All remaining sub-images were added to the training set previously used to train the model. With this new, larger training set, which incorporates the pseudo-labeled data, a new model was trained. This model was trained using early stopping to prevent overfitting of the training data. The loss function used was Tensorflow and Keras's categorical cross entropy loss.

This CNN was validated on the same validation set as before, allowing for the direct comparison of the models. The dead pixel map for the validation data was predicted from a standard deviation image generated from the 3 images in this data set.

The pseudo-labeled model validated with an F₁ score of 0.977 and an accuracy of 99.997%. This improvement was realized by drastically reducing the number of false positive predictions from the previous model, from 873 to 56. Additionally, the number of false negatives was reduced from 160 to 50. The process added new data to the training set that the model had high confidence in.

The workflow may be summarized by the following steps: 1) Acquire additional, unlabeled data from out in the field (clinical x-ray detectors). 2) Use previously trained model to predict dead pixel maps for the new data in step 1. (the best model, low exposure, standard deviation, trilogy can be used). 3) Drop all predictions with model certainty below a threshold, for instance, 99%. 4) Take all data above threshold and add it to the previous training set. 5) Retrain the model. 6) Retest the model. 7) Revalidate the model. The resulting model may improve performance.

### Embodiments

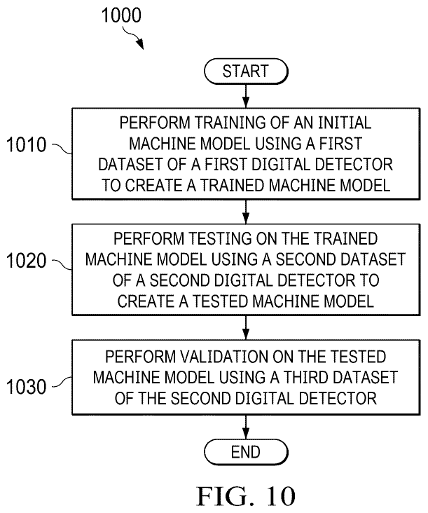

FIG. 10 is a flowchart of a method 1000 of binary classification of dead detector elements. At step 1010, training of an initial machine model is performed using a first dataset of a first digital detector to create a trained machine model. At step 1020, testing on the trained machine model is performed using a second dataset of a second digital detector to create a tested machine model. At step 1030, validation on the tested machine model is performed using a third dataset of the second digital detector. The training, the testing, and the validation are at a resolution of a single pixel corresponding to a single detector element of either the first digital detector or the second digital detector.

The method 1000 may implement additional embodiments as follows: The initial machine model is a CNN comprising at least one convolutional layer, at least one dropout layer, and at least one fully-connected layer. The at least one convolutional layer comprises 6 convolutional layers, the at least one dropout layer comprises a 50% dropout layer, and the at least one fully-connected layer comprises 2 fully-connected layer.

The method further comprises obtaining low-exposure images from the first digital detector; and performing standard-deviation pre-processing on the low-exposure images to obtain the first dataset. The low-exposure images are flat-field images.

The method further comprises: obtaining low-exposure images from the second digital detector; and performing standard-deviation pre-processing on the low-exposure images to obtain the second dataset. The low-exposure images are flat-field images.

The training and the testing comprise using a cross-entropy loss function. The testing comprises hyper-parameter tuning and early stopping to avoid overfitting.

The validation comprises: making predictions whether detector elements of the second digital detector are functional or dead; stitching together the predictions to obtain a predicted map; comparing the predicted map to a ground truth map to determine an accuracy of the predicted map; and determining the tested machine model is a validated machine model when the accuracy meets a criterion. The predictions are based on precisions, recalls, and F₁ scores. The method further comprises: identifying at least one dead detector element of a detector panel of a third digital detector using the validated machine model; replacing the at least one dead detector element or the detector panel to obtain a modified third digital detector; and using the modified third digital detector to perform image detection on an object. Replacement of the at least one dead detector element or the detector panel may be done based on one or more criteria, for instance, when a number of dead detector elements exceeds a threshold or when the number exceeds a percentage of the total number of detector elements in the detector panel.

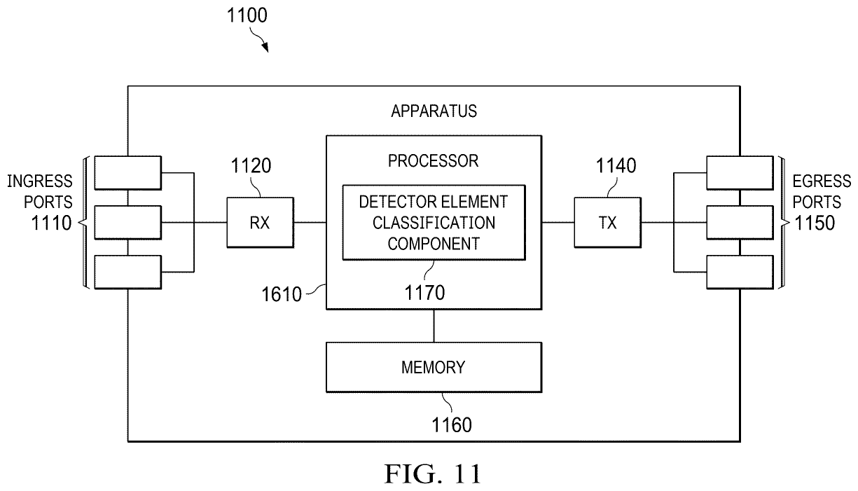

FIG. 11 is a schematic diagram of an apparatus 1100 according to an embodiment of the disclosure. The apparatus 1100 may implement the disclosed embodiments. The apparatus 1100 comprises ingress ports 1110 and an RX 1120 to receive data; a processor 1130, or logic unit, baseband unit, or CPU, to process the data; a TX 1140 and egress ports 1150 to transmit the data; and a memory 1160 to store the data. The apparatus 1100 may also comprise OE components, EO components, or RF components coupled to the ingress ports 1110, the RX 1120, the TX 1140, and the egress ports 1150 to provide ingress or egress of optical signals, electrical signals, or RF signals.

The processor 1130 is any combination of hardware, middleware, firmware, or software. The processor 1130 comprises any combination of one or more CPU chips, cores, FPGAs, ASICs, or DSPs. The processor 1130 communicates with the ingress ports 1110, the RX 1120, the TX 1140, the egress ports 1150, and the memory 1160. The processor 1130 comprises a detector element classification component 1170, which implements the disclosed embodiments. The inclusion of the detector element classification component 1670 therefore provides a substantial improvement to the functionality of the apparatus 1100 and effects a transformation of the apparatus 1100 to a different state. Alternatively, the memory 1160 stores the detector element classification component 1170 as instructions, and the processor 1130 executes those instructions.

The memory 1160 comprises any combination of disks, tape drives, or solid-state drives. The apparatus 1100 may use the memory 1160 as an overflow data storage device to store programs when the apparatus 1100 selects those programs for execution and to store instructions and data that the apparatus 1100 reads during execution of those programs. The memory 1160 may be volatile or non-volatile and may be any combination of ROM, RAM, TCAM, or SRAM.

A computer program product may comprise computer-executable instructions that are stored on a computer-readable medium and that, when executed by a processor, cause an apparatus to perform any of the embodiments. The computer-readable medium may be the memory 1160, the processor may be the processor 1130, and the apparatus may be the apparatus 1100.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other items shown or discussed as coupled may be directly coupled or may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method comprising:
performing training of an initial machine model using a first dataset of a first digital detector to create a trained machine model;
performing testing on the trained machine model using a second dataset of a second digital detector to create a tested machine model; and
performing validation on the tested machine model using a third dataset of the second digital detector,
wherein the training, the testing, and the validation are at a resolution of a single pixel corresponding to a single detector element of either the first digital detector or the second digital detector.

2. The method of claim 1, wherein the initial machine model is a convolutional neural network (CNN) comprising at least one convolutional layer, at least one dropout layer, and at least one fully-connected layer.

3. The method of claim 2, wherein the at least one convolutional layer comprises 6 convolutional layers, wherein the at least one dropout layer comprises a 50% dropout layer, and wherein the at least one fully-connected layer comprises 2 fully-connected layer.

4. The method of claim 1, further comprising:
obtaining low-exposure images from the first digital detector; and
performing standard-deviation pre-processing on the low-exposure images to obtain the first dataset.

5. The method of claim 4, wherein the low-exposure images are flat-field images.

6. The method of claim 1, further comprising:
obtaining low-exposure images from the second digital detector; and
performing standard-deviation pre-processing on the low-exposure images to obtain the second dataset.

7. The method of claim 6, wherein the low-exposure images are flat-field images.

8. The method of claim 1, wherein the training and the testing comprise using a cross-entropy loss function.

9. The method of claim 1, wherein the testing comprises hyper-parameter tuning and early stopping to avoid overfitting.

10. The method of claim 1, wherein the validation comprises:
making predictions whether detector elements of the second digital detector are functional or dead;
stitching together the predictions to obtain a predicted map;
comparing the predicted map to a ground truth map to determine an accuracy of the predicted map; and
determining the tested machine model is a validated machine model when the accuracy meets a criterion.

11. The method of claim 10, wherein the predictions are based on precisions, recalls, and F₁ scores.

12. The method of claim 10, further comprising:
identifying at least one dead detector element of a detector panel of a third digital detector using the validated machine model;
replacing the at least one dead detector element or the detector panel to obtain a modified third digital detector; and
using the modified third digital detector to perform image detection on an object.

13. An apparatus comprising:
a memory configured to store instructions; and
one or more processors coupled to the memory and configured to execute the instructions to cause the apparatus to:
perform training of an initial machine model using a first dataset of a first digital detector to create a trained machine model;
perform testing on the trained machine model using a second dataset of a second digital detector to create a tested machine model; and
perform validation on the tested machine model using a third dataset of the second digital detector,
wherein the training, the testing, and the validation are at a resolution of a single pixel corresponding to a single detector element of either the first digital detector or the second digital detector.

14. The apparatus of claim 13, wherein the initial machine model is a convolutional neural network (CNN) comprising at least one convolutional layer, at least one dropout layer, and at least one fully-connected layer.

15. The apparatus of claim 14, wherein the at least one convolutional layer comprises 6 convolutional layers, wherein the at least one dropout layer comprises a 50% dropout layer, and wherein the at least one fully-connected layer comprises 2 fully-connected layer.

16. The apparatus of claim 13, further comprising:
obtaining low-exposure images from the first digital detector; and
performing standard-deviation pre-processing on the low-exposure images to obtain the first dataset.

17. The apparatus of claim 16, wherein the low-exposure images are flat-field images.

18. The apparatus of claim 13, further comprising:
obtaining low-exposure images from the second digital detector; and
performing standard-deviation pre-processing on the low-exposure images to obtain the second dataset.

19. The apparatus of claim 18, wherein the low-exposure images are flat-field images.

20. A computer program product comprising instructions that are stored on a computer-readable medium and that, when executed by one or more processors, cause an apparatus to:
performing training of an initial machine model using a first dataset of a first digital detector to create a trained machine model;
performing testing on the trained machine model using a second dataset of a second digital detector to create a tested machine model; and
performing validation on the tested machine model using a third dataset of the second digital detector,
wherein the training, the testing, and the validation are at a resolution of a single pixel corresponding to a single detector element of either the first digital detector or the second digital detector.
